(19) United States
(12) Patent Application Publication
(10) Pub. No.: US 2022/0242020 A1
(43) Pub. Date: Aug. 4, 2022

(54) RESIN MOLDED COMPONENT, BATTERY PACK, AND INSPECTION METHOD FOR RESIN MOLDED COMPONENT

(71) Applicant: MURATA MANUFACTURING CO., LTD., Kyoto (JP)

(72) Inventor: Hideyasu TAKATSUJI, Kyoto (JP)

(21) Appl. No.: 17/726,172

(22) Filed: Apr. 21, 2022

Related U.S. Application Data
(63) Continuation of application No. PCT/JP2020/042776, filed on Nov. 17, 2020.

(30) Foreign Application Priority Data
Nov. 25, 2019 (JP) 2019-212121

(51) Int. Cl. B29C 45/37; B29C 45/76; H01M 50/102

(52) U.S. Cl. CPC B29C 45/372; B29L 2031/7146; H01M 50/102; B29C 45/768

(57) ABSTRACT

There is provided a resin molded component that is injection molded, the resin molded component including an outer surface portion on which a gate mark is formed, and an inner surface portion that is on a side opposite to the outer surface portion and has a fracture mark of resin formed.

### CROSS REFERENCE TO RELATED APPLICATIONS

The present application is a continuation of PCT patent application no. PCT/JP2020/042776, filed on Nov. 17, 2020, which claims priority to Japanese patent application no. JP2019-212121, filed on Nov. 25, 2019, the entire contents of which are being incorporated herein by reference.

### BACKGROUND

The present application relates to a resin molded component, a battery pack, and an inspection method for the resin molded component.

A case made of resin (hereinafter appropriately abbreviated to as a case) is used as a storage case or a protective case. In general, a case is manufactured by melting a pellet-shaped resin at a high temperature in an injection molding machine, injection molding the resin, and then cooling the resin. In such a manufacturing process, the injection molding machine may be temporarily stopped due to some trouble such as equipment trouble. At this time, the resin is deteriorated by that a time during which the molten resin is exposed to a high temperature becomes long. Impact resistance of a case made of the resin that has deteriorated (deteriorated resin) can be reduced to, for example, about one third of normal. The case made of the deteriorated resin cannot be discriminated in appearance. Accordingly, an appropriate inspection for finding the case made of the deteriorated resin is required.

For example, a method is provided for simply inspecting the degree of deterioration and the like in order to determine a possibility of reuse of a resin molded article collected after disposal.

### SUMMARY

The present application relates to a resin molded component, a battery pack, and an inspection method for the resin molded component.

However, in a technique identified in the background section, since a part of the resin molded article is cut out for deterioration inspection, there is a problem that a necessary portion for the case made of resin is partly broken. In addition, since a necessary portion of a finished product is broken, there is a problem that strength of the case itself is reduced and a design surface of the case is also affected.

Therefore, the present technology is directed to providing a resin molded component such as a case that has been subjected to or can be subjected to an appropriate inspection regarding impact resistance and strength, a battery pack, and an inspection method for the resin molded component according to an embodiment.

In order to solve the above-described problems, the present technology, in an embodiment, includes a resin molded component that is injection molded, the resin molded component including:

an outer surface portion on which a gate mark is formed; and

an inner surface portion that is on a side opposite to the outer surface portion and has a fracture mark of resin formed.

Further, the present technology, in an embodiment, includes a battery pack including:

a battery unit; and

a housing that houses the battery unit, in which

the housing includes an outer surface portion and an inner surface portion that is a surface opposite to the outer surface portion and is a surface on a side on which the battery unit is housed, and

a gate mark is formed on the outer surface portion and a fracture mark of resin is formed on the inner surface portion.

Further, the present technology, in an embodiment, includes an inspection method for a resin molded component including an outer surface portion on which a gate mark is formed and an inner surface portion that is on a side opposite to the outer surface portion and has a fracture mark of resin formed, the inspection method including:

bending a projection formed by resin and formed at a location corresponding to the fracture mark, measuring a force necessary for bending the projection, and determining a good product or a defective product according to a value of the force.

According to at least an embodiment of the present technology, it is possible to achieve a resin molded component such as a case that has been subjected to or can be subjected to an appropriate inspection regarding impact resistance and strength, a battery pack, and an inspection method for the resin molded component. Note that the contents of the present invention are not to be construed as being limited by the effects exemplified in the present description.

### BRIEF DESCRIPTION OF THE FIGURES

FIG. 1 includes view A which is a perspective view of a case before inspection according to an embodiment, and view B which is a perspective view of the case after inspection.

FIG. 2 is a view schematically illustrating an injection molding machine and a mold according to an embodiment.

FIG. 3 includes views A to E which are views referred to when explaining steps of manufacturing the case according to an embodiment.

FIG. 4 includes views A and B which are a side view and a top view, respectively, of an inspection pin used for simulation.

FIG. 5 includes views A and B, which are views used for description of simulation.

FIG. 6 includes views A to C which are top views of inspection pins in Examples 1 to 4 and Reference Examples 1 to 3, respectively.

FIG. 7 is a view illustrating a case where there is a star-shaped fracture mark.

FIG. 8 is a view for explaining a modification example.

FIG. 9 includes views A and B which are views for explaining a modification example.

FIG. 10 is a view for explaining a modification example.

### DETAILED DESCRIPTION

Hereinafter, the present technology will be described with reference to the drawings according to an embodiment.

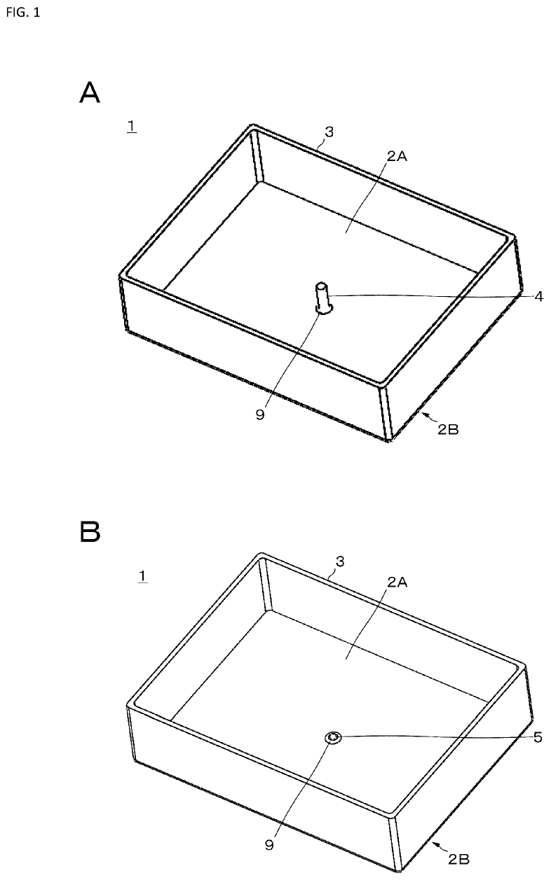

In the present technology, in an embodiment, a case made of resin is described as an example of the resin molded component. FIGS. 1A and 1B illustrate an example of a case (case 1) according to an embodiment. FIG. 1A illustrates the case 1 before an inspection described later is performed, and FIG. 1B illustrates the case 1 after the inspection is performed. Schematically, a projection (given a reference numeral 4 in FIG. 1A and hereinafter appropriately referred to as an inspection pin 4) formed on the case 1 is bent and broken at a time of inspection, thereby forming a fracture mark (given a reference numeral 5 in FIG. 1B).

The case 1 includes a rectangular inner surface portion 2A and four side wall portions 3 standing up from a periphery of the inner surface portion 2A, and has a box shape with an open upper surface. The case 1 may have an upper lid or the like as necessary, or may be engaged with another case. The case 1 can store various stored objects therein alone or in combination with other cases. The inner surface portion 2A is a surface that comes into contact with a stored object or is located on a stored object side, and an opposite side of inner surface portion 2A is an outer surface portion 2B.

In the vicinity of substantially a center of the inner surface portion 2A of the case 1, an inspection pin 4 stands up so as to be positioned on an opposite side of a gate mark (a gate mark 6 to be described later) formed on the outer surface portion 2B. The gate mark 6 and the inspection pin 4 face each other with the inner surface portion 2A and the outer surface portion 2B interposed therebetween. Note that the gate mark 6 is a mark obtained when an unnecessary portion (a gate portion 16 to be described later) of resin formed in the vicinity of an inlet (gate) for the resin to the mold of the case 1 is fractured or removed by cutting or the like when the case 1 is injection molded.

As an example, a height of the inspection pin 4 is about 10 to several tens of mm, and a sectional area is within a range of 0.8 mm² (a diameter of 1 mm when the inspection pin 4 has a cylindrical shape) to 78.5 mm² (a diameter of 10 mm when having the same shape). The size of the inspection pin 4 is appropriately set together with ease of molding, ease of fracture, and the like.

As will be described later, the inspection pin 4 is an inspection pin for determining whether the case 1 is a good product or a defective product, and when the inspection pin 4 is removed from a root after the inspection (when broken at the root), as illustrated in FIG. 1B, a fracture mark 5 is formed at the position where the inspection pin 4 stands up on the inner surface portion 2A. That is, the fracture mark 5 is a mark formed when the inspection pin 4 is removed. A shape of the fracture mark 5 has a same sectional shape as a shape (sectional shape) formed when the root of the inspection pin 4 is cut in a direction substantially parallel to the inner surface portion 2A. Specifically, when a sectional shape of the inspection pin 4 is, for example, a cylindrical shape, the shape of the fracture mark 5 is a circular shape. Further, an area of the fracture mark 5 is of a same size as the sectional area of the inspection pin 4.

A resin storage portion 9 (it is also referred to as a “reservoir”) protruding from the inner surface portion 2A of the case 1 toward an internal space surrounded by the side wall portions 3 is formed at the root of the inspection pin 4. When the inspection pin 4 is removed, the inspection pin 4 is broken off while leaving the resin storage portion 9 at the root. Therefore, as illustrated in FIG. 1B, the resin storage portion 9 protruding from the inner surface portion 2A exists around the fracture mark 5.

The case 1 is formed by resin of the same material including the inspection pin 4. The material of the case 1 is, for example, a thermoplastic resin such as polypropylene (PP), polyethylene terephthalate (PET), polycarbonate (PC), acrylonitrile-butadiene-styrene (ABS), polybutylene terephthalate (PBT), polyacetal (POM), or polyphenylene sulfide (PPS).

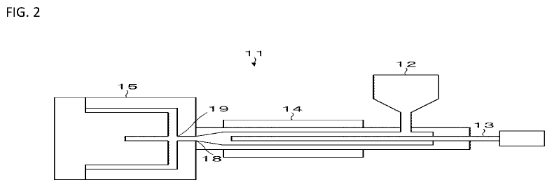

The case 1 is produced by, for example, an injection molding method. FIG. 2 is a view schematically illustrating an injection molding machine 11 and a mold 15 (including a male mold and a female mold) used in the injection molding method. A pellet-shaped resin is introduced from a hopper 12 of the injection molding machine 11. The resin is melted by heating with a heater 14 while stirring with a screw 13 at a lower part of the hopper 12. The resin melted by heat is injected into the mold 15 through a nozzle 18, and filled into the mold corresponding to the case 1 through a gate 19. Then, after cooling, the molded case 1 is taken out, and a gate portion 16 described later is removed by fracture or the like. Thus, the gate mark 6 is formed.

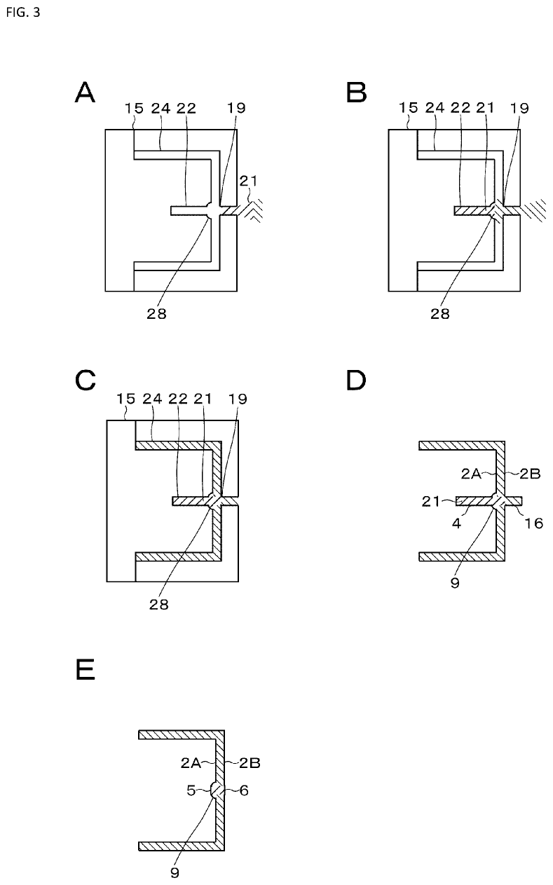

FIGS. 3A to 3E are views for explaining a step of filling the molten resin into the mold 15 to manufacture the case 1. The mold 15 has a cylindrical hole 22 formed on a back side of the gate 19. The hole 22 is a mold for forming the inspection pin 4. A hole 28 is formed at the root of the hole 22. The hole 28 is a hole for forming the resin storage portion 9. The hole 28 is for facilitating the earliest filling of the resin in the hole 22. After the resin (hatched) injected from the nozzle 18 passes through the gate 19 (FIG. 3A), the resin (initial flow) 21 injected first is filled in the hole 22 and the hole 28 (FIG. 3B). Thereafter, the resin injected into the mold 15 fills other portions 24 (portions to be the inner surface portion 2A and the side wall portions 3 of the case 1) (FIG. 3C). Then, after the cooling step, the molded product is released from the mold 15, thereby producing the case 1 in which the gate portion 16 remains (FIG. 3D). Then, the gate portion 16 formed on the outer surface portion 2B is removed by cutting or the like to form the gate mark 6 described above. Subsequently, by performing an inspection described later, the inspection pin 4 is removed, and the fracture mark 5 is formed. At least a portion of the gate mark 6 and at least a portion of the fracture mark 5 face each other with the inner surface portion 2A and the outer surface portion 2B interposed therebetween (FIG. 3E). Note that, to be with the inner surface portion 2A and the outer surface portion 2B interposed therebetween means to be with a configuration having the inner surface portion 2A and the outer surface portion 2B interposed therebetween (in the present embodiment, a bottom portion of the case 1). In the present embodiment, the fracture mark 5 is formed on a back side of the gate mark 6.

Here, a case where the injection molding machine 11 is stopped due to a facility trouble or the like is considered. Note that the facility trouble in the present embodiment is assumed to be a facility trouble in which the injection molding machine 11 stops for a relatively short time and immediately restarts the operation.

When the injection molding machine 11 is stopped, the resin retained in the injection molding machine 11 (in the cylinder) remains heated. The heating time is longer than usual, and thus the resin is deteriorated. In general, a portion of the resin supplied to the mold 15 where the deterioration is large is the initial flow 21 of the resin that has been continuously heated for a longer time than usual. Therefore, when the injection molding machine 11 restarts the operation and the resin is re-injected into the mold 15, the initial flow 21 passes through the gate 19 as a head as illustrated in FIG. 3A, and the initial flow 21 is filled first into the hole 28 by the function of the hole 22 and injection pressure as illustrated in FIG. 3B. That is, when the deterioration of the resin has occurred, the inspection pin 4 is formed by the deteriorated resin. On the other hand, when there is no facility trouble or the like, the inspection pin 4 is formed by a non-deteriorated resin. At this time, if the gate 19 and the hole 22 face each other, the initial flow 21 is likely to be filled first in the hole 22, so that the deterioration of the resin can be inspected more accurately.

As described above, when a trouble or the like occurs in the injection molding machine 11, the inspection pin 4 is a portion formed of the deteriorated resin in the case 1. In a case where the inspection pin 4 is formed by the deteriorated resin, there is a high possibility that the deteriorated resin is also used in other portions (the side wall portions 3 and the like). Therefore, by inspecting strength of the inspection pin 4, it is possible to determine whether or not the resin that has deteriorated due to a facility trouble or the like is used in the case 1.

Accordingly, in an embodiment, a force necessary for bending the inspection pin 4 by a predetermined length is obtained. When the value of the force is equal to or more than a threshold, the case 1 is determined to be a passed product (good product) that has a predetermined impact resistance, and when the value of the force is less than the threshold, the case 1 is determined to be a failed product (defective product) that does not have the predetermined impact resistance. Note that instead of bending by the predetermined length, a force necessary for braking off (cutting) the inspection pin 4 may be obtained. Note that the inspection pin 4 does not necessarily have to be removed when the inspection is completed, but it is desirable that the inspection pin 4 is removed when the inspection is completed from the viewpoint of design and the viewpoint of storing the stored object in the case 1.

### EXAMPLES

In order to facilitate the above-described inspection, it is preferable that the force necessary for bending the inspection pin 4 by the predetermined length is small, and the inspection pin 4 becomes unnecessary after the inspection. Thus, it is preferable that strain energy at the root of the inspection pin 4 is large so that the inspection pin 4 can be broken off by further applying a force after the inspection. Accordingly, by simulation using a computer, the most preferable sectional shape of the inspection pin 4 was obtained from values resulted from obtaining a bending force and strain energy for bending the inspection pins 4 having various shapes by the predetermined length.

### [Simulation Method]

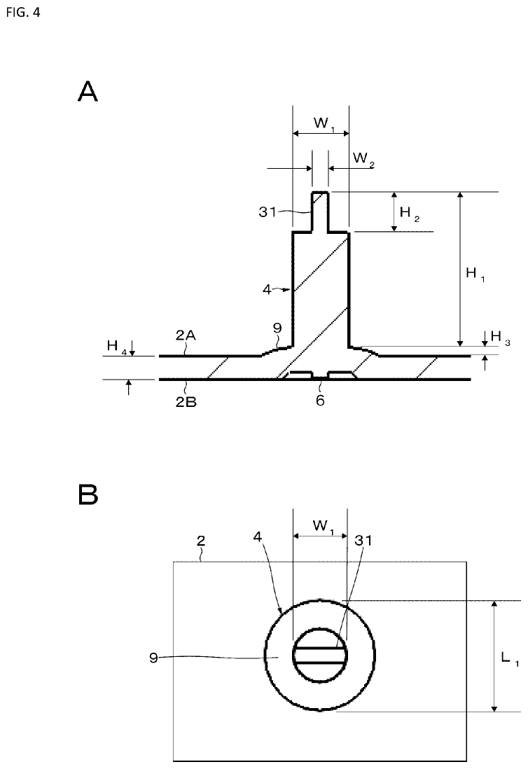

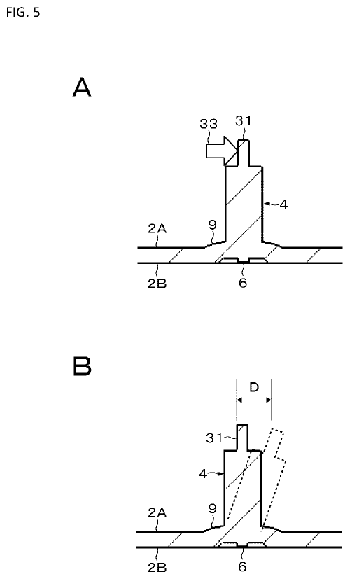

As illustrated in FIGS. 4A and 4B, in the simulation, a height H₁ of the inspection pin 4 was set to 20 mm, a width W₁ was set to 5 mm, and a portion of 5 mm from the tip of the inspection pin 4 had a shape having a flat plate holding portion 31 having a thickness W₂ of 2 mm. A diameter L₁ of the resin storage portion 9 at the root of the inspection pin 4 was set to 15 mm, a height H₃ was set to 1 mm, and a length H₄ between the inner surface portion 2A and the outer surface portion 2B of the case 1 was set to 3 mm. As illustrated in FIG. 5A, a load 33 was applied to the flat plate holding portion 31, and as illustrated in FIG. 5B, a force necessary for bending until a forced displacement of D (5 mm) occurs was calculated. The displacing direction is an arrow direction in FIG. 5A in a side view of inspection pin 4. Then, the strain energy at the root portion of the inspection pin 4 when a forced displacement as illustrated in FIG. 5B occurred was calculated.

### Example 1

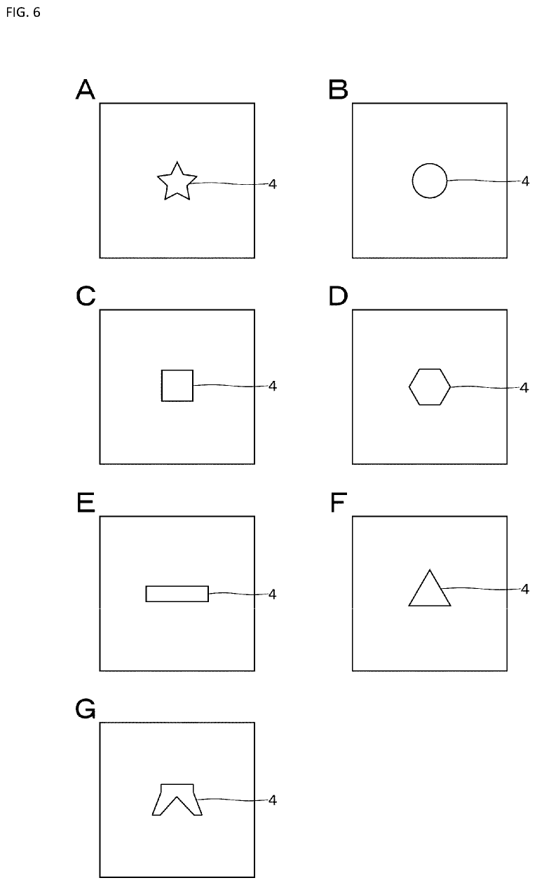

The inspection pin 4 had a columnar shape, and as illustrated in FIG. 6A, the inspection pin 4 had a star-shaped sectional shape in top view.

### Example 2

The inspection pin 4 had a cylindrical shape, and as illustrated in FIG. 6B, the inspection pin 4 had a circular sectional shape in top view. As the resin forming the inspection pin 4, the same resin as in the example was used.

### Example 3

The inspection pin 4 had a regular quadrangular prism shape, and as illustrated in FIG. 6C, the inspection pin 4 had a substantially square sectional shape in top view. As the resin forming the inspection pin 4, the same resin as in the example was used.

### Example 4

The inspection pin 4 had a hexagonal columnar shape, and as illustrated in FIG. 6D, the inspection pin 4 had a substantially hexagonal shape in top view. As the resin forming the inspection pin 4, the same resin as in the example was used.

### Reference Example 1

The inspection pin 4 had a quadrangular prism shape, and as illustrated in FIG. 6E, the inspection pin 4 had a substantially rectangular shape in top view. As the resin forming the inspection pin 4, the same resin as in the example was used.

### Reference Example 2

The inspection pin 4 had a triangular prism, and as illustrated in FIG. 6F, the inspection pin 4 had a substantially triangular shape in top view. As the resin forming the inspection pin 4, the same resin as in the example was used.

### Reference Example 3

The inspection pin 4 had a columnar shape, and as illustrated in FIG. 6G, the inspection pin 4 had a substantially V shape in top view. As the resin forming the inspection pin 4, the same resin as in the example was used.

The force necessary for causing a displacement of the respective inspection pins 4 corresponding to the examples and the reference examples by 5 mm and the strain energy at the root portion of the inspection pins 4 were obtained by the above simulation method. The force and strain energy necessary for a 5-mm displacement were expressed as relative values when the value of Reference Example 1 was taken as 100%. Results are illustrated in Table 1.

TABLE 1

| | Force necessary for | |
|---|---|---|
| | 5-mm displacement (%) | Strain energy (%) |
| Example 1 | 73.1 | 81 |
| Example 2 | 100.0 | 100 |
| Example 3 | 91.6 | 107 |
| Example 4 | 129.1 | 92 |
| Reference Example 1 | 100.0 | 41 |
| Reference Example 2 | 86.4 | 58 |
| Reference Example 3 | 80.4 | 57 |

In a case where the strain energy at the time of causing the 5-mm displacement is less than 60%, the pin is less likely to fracture, and the inspection error increases, for example, the pin is not fractured from the root of the inspection pin. Therefore, Examples 1 to 4 in which the strain energy is 60% or more is preferable.

The force necessary for causing the 5-mm displacement was the lowest value in Example 1. Thus, it was found that the inspection pin 4 of Example 1 can be displaced with the smallest force. In Example 1, it was also found that, in addition to that the displacement can occur with a small force, sufficiently large strain energy to fracture the inspection pin 4 occurs by further applying a force due to the 5-mm displacement. Therefore, it has been found that the sectional shape of the inspection pin 4 is more preferably a star shape.

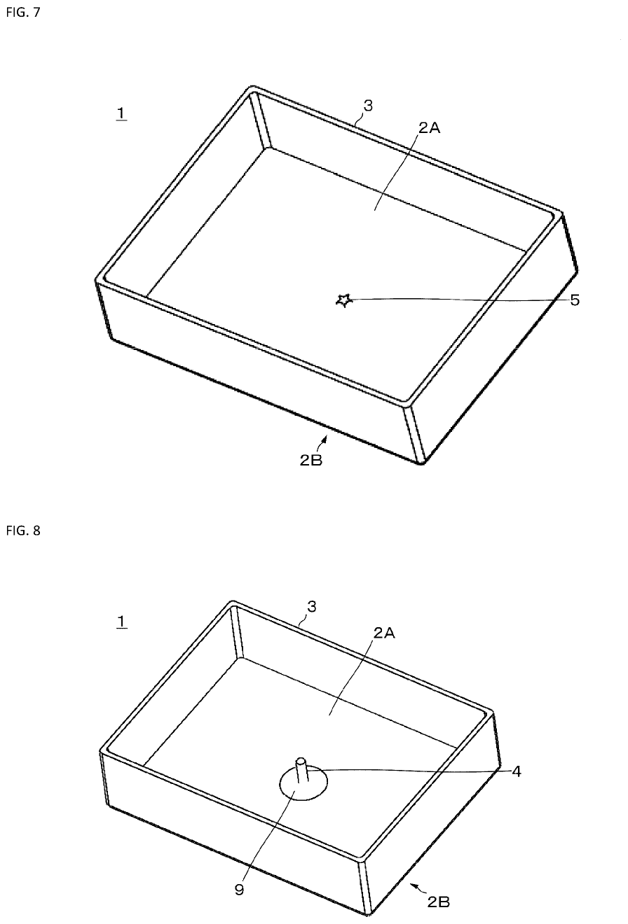

Note that, as described above, the shape of the fracture mark 5 when the inspection pin 4 is broken off and removed is the same as the sectional shape of the inspection pin 4. For example, when the sectional shape of the inspection pin 4 is a star shape, as illustrated in FIG. 7, a star-shaped fracture mark 5 is formed on the inner surface portion 2A.

By the above-described inspection method, it is possible to accurately determine whether or not the case 1 has predetermined design strength.

According to an embodiment, for example, the following effects can be obtained. By forming the fracture mark 5, it is possible to determine at a glance whether or not the case 1 has been inspected. Further, since the fracture mark 5 is formed on the inner surface portion 2A, it does not affect the design surface of the case 1. Furthermore, since the inspection pin 4 is always formed, the total number of the cases 1 can be inspected. In addition, since the portion necessary for the function of the case 1 is not broken, it is possible to prevent the strength of the case 1 from deteriorating after the inspection.

Note that in an embodiment, the gate portion 16 is not used for inspection. This is because, as the gate portion 16 is formed on the outer surface portion 2B of the case 1, the gate portion is necessary to be finally removed cleanly from the viewpoint that it is a design surface, an unnecessary projection, and the like, and is not appropriate as a portion where the fracture inspection is performed. In addition, since the position of the gate portion 16 is a position that is finally filled with the resin at the time of injection molding, there is a high possibility that the portion is filled not with unnecessarily heated resin but with resin that is not deteriorated. That is, since there is a high possibility that the gate portion 16 is always formed by resin that is not deteriorated, it is not suitable as a position for inspecting the impact resistance of the case 1.

The case 1 according to an embodiment is used, for example, as a housing that houses a battery unit having a cell or the like of a lithium ion battery. In this case, the present invention can also be achieved as a battery pack including the battery unit and a housing having the configuration described in the embodiment. When the present invention is configured as a battery pack, the impact resistance of the housing can be secured, so that the battery unit housed in the housing can be appropriately protected. Further, the case 1 can also be applied to a resin molded component used for electronic devices, home electric appliances, vehicles, aircraft, and the like.

Although an embodiment of the present technology has been specifically described above, the content of the present technology is not limited to the above-described embodiment, and various modifications based on the technical idea of the present technology are possible.

As illustrated in FIG. 8, the size of the resin storage portion 9 formed at the root of the inspection pin 4 and protruding from the inner surface portion 2A and the hole 28 for forming the resin storage portion 9 may be larger than predetermined. With such a configuration, the initial flow 21 of the resin at the time of injection molding can be easily filled into the hole 22.

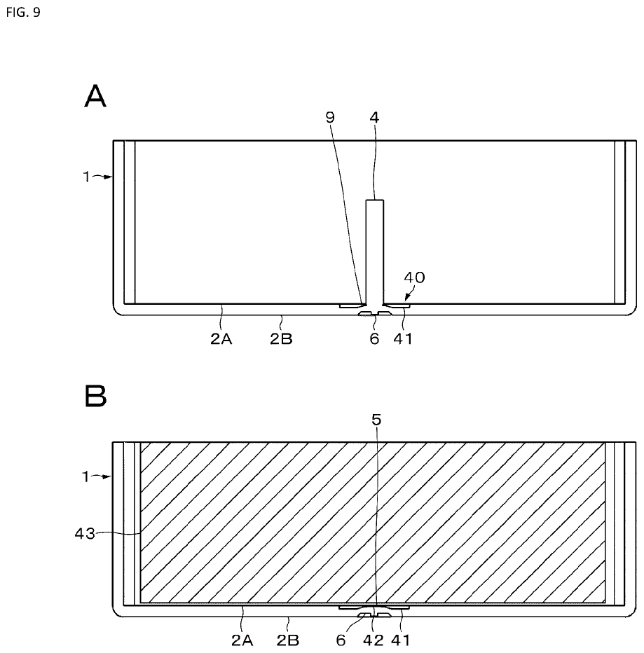

As illustrated in FIG. 9A, in this example, a recess 40 that is recessed toward the outer surface portion 2B side is formed substantially at a center of the inner surface portion 2A. The inspection pin 4 stands up from substantially a center of a bottom portion 41 of the recess 40. Further, the resin storage portion 9 is formed around the inspection pin 4 in the vicinity of the center of the bottom portion 41 so as not to exceed the inner surface portion 2A. After the inspection pin 4 is removed, a stored object 43 comes into contact with the inner surface portion 2A of the case 1 as illustrated in FIG. 9B. In this example, the fracture mark 5 is formed at a position lower (deeper) than the inner surface portion 2A. That is, the recess 40 that is recessed with respect to the inner surface portion 2A is formed around the fracture mark 5, and the fracture mark 5 is formed in the recess 40 so as not to protrude from the inner surface portion 2A. Therefore, when a burr 42 is generated by fracturing after the inspection pin 4 is fractured, it is possible to prevent the burr 42 and the stored object 43 from coming into contact with each other. Thus, it is possible to prevent the stored object 43 from being damaged by the burr 42. This example is suitable for a case where the stored object 43 is an object (for example, the battery unit) that it is strongly demanded to be prevented from being damaged.

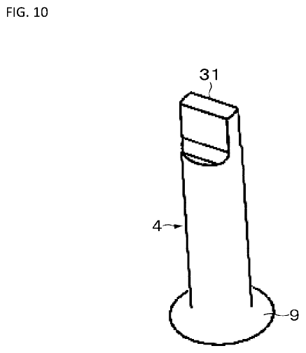

As illustrated in FIG. 10, the above-described flat plate holding portion 31 (chuck) may be formed at the tip of the inspection pin 4. The flat plate holding portion 31 corresponds to a portion where a load is to be applied. For example, the load is applied to the flat plate holding portion 31 in a state where the flat plate holding portion 31 is sandwiched by an appropriate load application device. Since the flat plate holding portion 31 is provided, the load can be stably applied to the inspection pin 4.

Other modification examples will be described. Depending on the configuration of the mold, the inspection pin 4 and the fracture mark 5 may be formed at a position other than the substantially center of the inner surface portion 2A. The same applies to the gate mark 6. Further, the gate mark 6 is only required to be a mark obtained by removing the gate portion 16, and may slightly protrude from the outer surface portion 2B, may be flush with the outer surface portion 2B, or may be recessed with respect to the outer surface portion 2B.

The present technology described above including in the modification examples can be appropriately combined according to an embodiment. Further, the materials, processes, and the like described in an embodiment are merely examples, and the contents of the present technology are not limited to the exemplified materials and the like.

### DESCRIPTION OF REFERENCE SYMBOLS

1: Case
2A: Inner surface portion
2B: Outer surface portion
4: Inspection pin
5: Fracture mark
6: Gate mark
9: Resin storage portion
16: Gate portion
31: Flat plate holding portion
40: Recess
43: Stored object

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A resin molded component that is injection molded, the resin molded component comprising:
an outer surface portion on which a gate mark is formed; and
an inner surface portion that is on a side opposite to the outer surface portion and has a fracture mark of resin formed.

2. The resin molded component according to claim 1, wherein
at least a portion of the gate mark and at least a portion of the fracture mark face each other with the inner surface portion and the outer surface portion interposed therebetween.

3. The resin molded component according to claim 1, further comprising
a resin storage portion that protrudes from the inner surface portion and formed around the fracture mark.

4. The resin molded component according to claim 1, wherein
a recess that is recessed with respect to the inner surface portion is formed around the fracture mark, and
the fracture mark is formed in the recess so as not to protrude from the inner surface portion.

5. The resin molded component according to claim 1, wherein
a shape of the fracture mark is any of a circular shape, a substantially square shape, a substantially hexagonal shape, and a star shape.

6. The resin molded component according to claim 5, wherein
a shape of the fracture mark is a star shape.

7. The resin molded component according to claim 1, wherein
an area of the fracture mark is within a range of 0.8 to 78.5 square millimeters.

8. The resin molded component according to claim 1, wherein
the fracture mark is a mark formed by removing a projection that is formed by the resin and formed at a time of the injection molding.

9. The resin molded component according to claim 8, wherein
a portion where a load is to be applied is formed at a tip of the projection.

10. The resin molded component according to claim 8, wherein
a sectional shape of the projection is same as a shape of the fracture mark.

11. The resin molded component according to claim 1, wherein
the inner surface portion is a surface that comes into contact with a stored object.

12. A battery pack comprising:
a battery unit; and
a housing that houses the battery unit, wherein
the housing includes an outer surface portion and an inner surface portion that is a surface opposite to the outer surface portion and is a surface on a side on which the battery unit is housed, and
a gate mark is formed on the outer surface portion and a fracture mark of resin is formed on the inner surface portion.

13. An inspection method for a resin molded component including an outer surface portion on which a gate mark is formed and an inner surface portion that is on a side opposite to the outer surface portion and has a fracture mark of resin formed, the inspection method comprising:
bending a projection formed by resin and formed at a location corresponding to the fracture mark;
measuring a force necessary for bending the projection; and
determining whether a product is defective according to a value of the force.
